(19) United States
(12) Patent Application Publication
(10) Pub. No.: US 2007/0209496 A1
(43) Pub. Date: Sep. 13, 2007

(54) Musical instrument string damper

(76) Inventor: Marco Antonio Lenzi, Richmond, CA (US)

Correspondence Address: Marco A. Lenzi, 5914 Bernhard Ave., Richmond, CA, 94805, US

(21) Appl. No.: 11/715,007

(22) Filed: Mar. 6, 2007

Related U.S. Application Data
(60) Provisional application No. 60/780,322, filed on Mar. 8, 2006.

(51) Int. Cl. G10D 3/00

(52) U.S. Cl. 84/313

(57) ABSTRACT

A string damper for a stringed instrument having an elongated block (1) of vibration-absorbing material with a plurality of slits (4-7) disposed along lower surface of said block that extend upwardly into said block and longitudinally span the front and rear surfaces of said block and are generally parallel and generally spaced apart as said strings on said stringed instrument proximate the bridge of said stringed instrument, and grooves (8-11) that extend along the length of the entrance to said slits, respectively, along the lower surface of said block forming an enlarged entrance into said slits, and a rigid support surface (2) secured to the upper surface of said block, whereby one or more of said strings of said stringed instrument may be urged into and engaged by said slits so as to damp vibration of said strings and detachably attach said string damper to said stringed instrument.

### CROSS-REFERENCE TO RELATED APPLICATIONS

This application claims the benefit of Provisional Patent Application Ser. No. 60/780322, filed 08 Mar. 2006 by the inventor, Marco A. Lenzi.

### STATEMENT OF FEDERALLY SPONSORED RESEARCH/DEVELOPMENT

Not applicable.

### REFERENCE TO A SEQUENCE LISTING

Not applicable.

### BACKGROUND

1. Field of the Invention

This invention relates generally to stringed musical instruments and more specifically it relates to a string damper for stringed musical instruments.

2. Description of Prior Art

It can be appreciated that string dampers for stringed instruments have been in use for years. Typically, these string dampers are comprised of a mechanism that contacts the vibrating string and absorbs some of the energy of the vibrating string, thus providing a damping effect. This damping effect reduces the acoustic output of the string and alters the frequency spectrum of this acoustic output, and is perceived by the listener as a decrease in volume and a change in tone of the stringed instrument. The degree of the damping effect is dependent on the location and size of the contact area of the string damper along the length of the string, and the amount of resistance this contact area presents to the vibration of the string.

Most stringed instruments have a plurality of strings that vary in diameter to provide a larger range of pitches than could be afforded by a single string. The diameter of the strings generally increases from the high to low pitched strings. It is known that the amounts of the above-mentioned factors necessary to achieve a certain degree of damping are directly proportional to the diameter of the string. As such, the thicker (usually lower pitched) strings of a stringed instrument require more contact area and/or resistance than the thinner (usually higher pitched) strings to achieve a similar level of damping. As such, it would be desirable for a string damper to compensate for the varying string diameters of the stringed instrument, so as to provide an even and balanced damping level, and hence volume and tone, between the strings.

The typical solid body electric bass guitar, when played with fingers in a conventional manner, tends to have a sustaining tone, mainly due to its solid body, whereas an acoustic upright bass, with its hollow body, tends to have a more staccato tone. Electric bass players can appreciate that it would be desirable to have an easy to attach string damper that can vary the damping effect such that it could simulate the tone of the upright bass on the electric bass guitar. Also, it is common for players to own more than one stringed instrument of a kind, in which case it would be desirable and economical to have a detachably attached string damper that could be shared among the instruments.

Several proposals to accomplish the purposes set forth above have been proposed in the art, but they all have various deficiencies:

(a) Some involve complicated mechanical apparatuses that are expensive to manufacture, add cost to the instrument, and may require maintenance from time to time.

(b) Some are fixedly attached and cannot be moved between or shared among multiple like instruments. Also, they are usually attached in such a way that requires screws or holes be driven into the body of the stringed instrument, which is clearly undesirable.

(c) Some can only contact a fixed portion of the strings, thereby limiting the range of the damping effect.

(d) Some are detachably attached, but are cumbersome to attach and detach from the instrument.

(e) Some do not provide an even balance of damping between the low-pitched and the high-pitched strings.

(f) Some are intended solely as a mute to lower the sound volume without regard to tonal enhancement.

(g) Some can only function on only left-handed or right-handed instruments, not both.

Examples in the prior art of deficiencies set forth above include:

U.S. Pat. No. 1,772,725 (1930) to Lewis discloses a string damper device that is mechanically simple, but is cumbersome to attach and detach from the instrument, especially on instruments such as violin that have fingerboards with a radius of curvature. Strings tend to catch on the entrance to the damper as they are slid into the damper. Also, repeatedly attaching and detaching the damper results in uneven wear to the damping material, as the open end of the damper must rub over all the strings, whereas the closed end only rubs over the single end string. This results in the open end of the damper accumulating more wear than the closed end. Also, it does not balance the damping from string to string.

U.S. Pat. No. 3,015,247 (1962) to Allers discloses a string damper device that is mechanically complicated and is fixedly attached to the instrument. It contacts only a fixed portion of the strings, thereby limiting its damping range and it does not balance the damping from string to string. Also, it is attached to the instrument by screws that bore into the body of the instrument.

U.S. Pat. No. 3,260,148 (1966) and U.S. Pat. No. 3,427,916 (1969), both to Fender, disclose string damper devices that are mechanically complicated and that are fixedly attached to the instrument. They contact only a fixed portion of the strings, thereby limiting their damping range. Their attachment to the instrument requires screws and holes that bore into the body of the instrument. Also, U.S. Pat. No. 3,260,148 does not balance the damping from string to string.

U.S. Pat. No. 3,440,917 (1969) to Lemon discloses a string damper device that is mechanically complicated and that is fixedly attached to the instrument. It requires that the instrument have strings attached to a saddle so that the damper can be attached to the strings between the bridge and the saddle. Also, it does not balance the damping from string to string.

U.S. Pat. No. 3,956,962 (1976) to Fields discloses a string damper device that is mechanically complicated and that is fixedly attached to the instrument. It contacts only a fixed portion of the strings, thereby limiting its damping range and it does not balance the damping from string to string. Also, it is attached to the instrument via holes that bore into the body of the instrument.

U.S. Pat. No. 3,971,287 (1976) to Ito discloses a string damper device that is mechanically simple, but requires operating a latch to attach or detach it from the instrument, which is cumbersome. Also, it does not balance the damping from string to string.

U.S. Pat. No. 4,116,107 (1978) to Rickard discloses a string damper device that is mechanically complicated and that is fixedly attached to the instrument. It contacts only a fixed portion of the strings, thereby limiting its damping range and it does not balance the damping from string to string.

### SUMMARY

In view of the foregoing disadvantages inherent in the known types of string dampers now present in the prior art, the present invention provides a new string damper construction wherein the same can be utilized for altering the volume and enhancing the tone of stringed instruments.

The general purpose of the present invention, which will be described subsequently in greater detail, is to provide a new string damper that has many of the advantages of the string damper devices mentioned heretofore and many novel features that result in a new string damper which is not anticipated, rendered obvious, suggested, or even implied by any of the prior art string damper devices, either alone or in any combination thereof.

To attain this, one embodiment of the present invention generally comprises an elongated block of vibration-absorbing material with a plurality of slits disposed along lower surface of the block that extend upwardly into the block and longitudinally span the front and rear surfaces of the block and are generally parallel and generally spaced apart as the strings on the stringed instrument proximate the bridge of the stringed instrument. Along the length of the entrance to each slit, along the lower surface of the block, is a groove that forms an enlarged entrance into the slits. A rigid support surface is secured to the upper surface of the block. In operation, one or more of the strings of the stringed instrument may be urged into and engaged by the slits so as to damp vibration of the strings and detachably attach the string damper to the stringed instrument.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### Objects and Advantages

A primary object of the invention is to provide a string damper that will overcome the shortcomings of the prior art devices. Accordingly, several objects and advantages of the present invention are:

(a) to provide a string damper that is not fixedly attached to the stringed instrument so that it can be detached from the stringed instrument and be shared between other like stringed instruments.

(b) to provide a string damper that is easily and quickly attached and detached from the stringed instrument without having to operate a mechanism or use tools.

(c) to provide a string damper that does not require or produce any permanent changes or scars (such as screw holes) to the stringed instrument when attached to the instrument.

(d) to provide a string damper in which the damping mechanism also provides the mechanism by which the string damper is secured to the stringed instrument for normal use, thereby eliminating extra securing apparatus.

(e) to provide a string damper that can contact the strings of the stringed instrument along a range of positions, thereby affording a range of damping effects.

(f) to provide a string damper that provides an even balance of damping from the thicker low-pitched strings to the thinner high-pitched strings.

(g) to provide a string damper that is adaptable to work on a variety of stringed instrument types.

(h) to provide a string damper that works equally well on, and can be interchanged among, left-handed and right-handed stringed instruments.

(i) to provide a string damper that when employed in conjunction with an electric bass guitar enhances the tone so as to simulate the staccato tone of an acoustic upright bass.

(j) to provide a string damper having a simple and novel construction that is inexpensively and easily manufactured.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the invention will become fully appreciated as the same becomes better understood when considered in conjunction with the accompanying drawings, in which like reference characters designate the same or similar parts throughout the several views; closely related figures have the same number but different alphabetic suffixes; the distinctions between figures with different alphabetic suffixes are readily comprehended; and wherein:

FIG. 1A shows a front perspective view of the string damper.

FIG. 1B shows a front perspective view of the string damper engaged to the strings of a stringed instrument (a right-handed 4-string electric bass guitar shown in FIG. 7).

FIG. 2A shows a bottom plan view of the string damper of FIG. 1A.

FIG. 2B shows a top plan view of the string damper of FIG. 1A.

FIG. 3A shows a cross-sectional view of the string damper of FIG. 2B along line 3A-3A.

FIG. 3B shows a cross-sectional view of the string damper of FIG. 3A along line 3B-3B.

FIG. 4A shows the view of FIG. 3A included with strings shown entering into the grooves of the string damper.

FIG. 4B shows the view of FIG. 4A with the strings shown engaged at the entrance to the slits of the string damper.

FIG. 5 shows a top plan view of the string damper of FIG. 1B.

FIG. 6A shows a cross-sectional view of the string damper of FIG. 5 along line 6A-6A showing the strings engaged to the full height of the slits.

FIG. 6B shows a cross-sectional view of the string damper of FIG. 6A along line 6B-6B.

FIG. 7 shows a perspective view of the string damper positioned for operation on the right-handed 4-string electric bass guitar.

FIG. 8A shows an enlarged top plan view of the string damper of FIG. 7 showing the string damper attached to the strings of the electric bass at a position proximate the bridge.

FIG. 8B shows another view of the string damper of FIG. 8A showing the string damper attached to the strings of the electric bass at an alternative position from that of FIG. 8A.

FIG. 9 shows a front perspective view of a string damper having a damping block with forward and rearward sides having a beveled lower edge.

FIG. 10A shows a bottom plan view of the string damper of FIG. 9.

FIG. 10B shows a top plan view of the string damper of FIG. 9

FIG. 11A shows a cross-sectional view of the string damper of FIG. 10B along line 11A-11A.

FIG. 11B shows a cross-sectional view of the string damper of FIG. 11A along line 11B-11B.

FIG. 12A shows the view of the string damper of FIG. 11B with a string engaged in the slit to a partial height of the slit.

FIG. 12B shows the view of the string damper of FIG. 11B with a string engaged in the slit to the full height of the slit.

FIG. 13 shows a side cross-sectional view (similar to FIG. 11B) of a string damper having a damping block having forward and rearward sides that are beveled to the full height of the sides.

FIG. 14 shows a front cross-sectional view of a string damper having only a damping block with slits along the lower surface of the damping block.

FIG. 15 shows a front cross-sectional view of a string damper having only a damping block, a support plate, and slits along the lower surface of the damping block.

FIG. 16 shows a front cross-sectional view of a string damper that is flat and has no compensation for the radius of curvature of the fingerboard.

FIG. 17 shows a front cross-sectional view of a string damper having a damping block with a flat lower surface.

FIG. 18A shows a front cross-sectional view of a string damper having slits that have space between their respective opposing walls.

FIG. 18B shows an enlarged view of one of the slits of FIG. 18A showing the opposing walls and with a string engaged in the slit.

FIGS. 19A and 19B show front cross-sectional views of a string damper having a support plate with a tapered thickness.

FIGS. 20A to 20F show front cross-sectional views of various embodiments of a groove.

FIG. 21 shows a bottom plan view of a string damper having a damping block made of two adjacent halves.

FIGS. 22A and 22B show front cross-sectional views of a string damper having longitudinal voids in the interior of the damping block.

FIGS. 23A and 23B show front cross-sectional views of a string damper having longitudinal channels in the upper surface of the damping block.

FIGS. 24A and 24B show front cross-sectional views of a string damper having longitudinal channels in the lower surface of the support plate.

FIG. 25 shows a front cross-sectional view of a string damper having a longitudinal channel in the upper surface of the damping block and affixed to the support plate only at the ends.

FIG. 26 shows a front cross-sectional view of a string damper having longitudinal channels along the lower surface of the damping block between the slits.

FIGS. 27A to 27C show bottom plan views of a string damper showing various shapes that provide for non-linear variations in slit length.

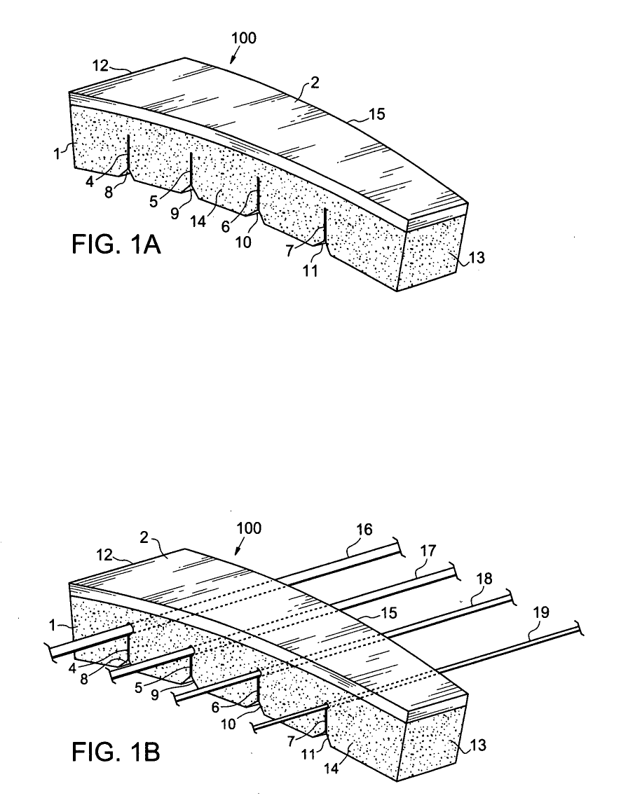

### DESCRIPTION—FIGS. 1 to 8—PREFERRED EMBODIMENT

Turning now descriptively to the drawings, in which similar reference characters denote similar elements throughout the several views, the attached figures illustrate a string damper for stringed instrument.

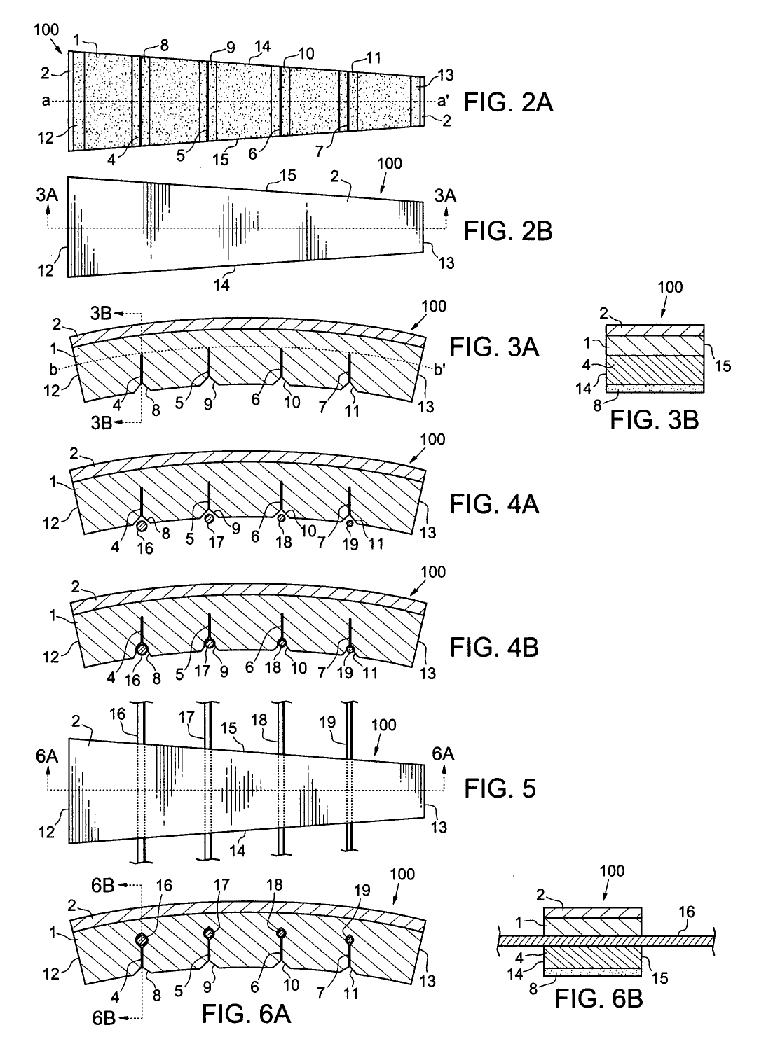

One embodiment of the present invention, illustrated in FIG. 1A, is a string damper 100 comprising an elongated damping block 1, a plurality of generally parallel slits 4-7 disposed along the lower surface of damping block 1, grooves 8-11 that extend along the length of the entrance to each slit 4-7, respectively, and a rigid support plate 2 affixed to the upper surface of damping block 1. String damper 100 has a long lateral side 12, a short lateral side 13, a front side 14, and a rear side 15. Slits 4-7 extend upwardly, in a vertical orientation, into damping block 1 (FIG. 3A), span damping block 1 longitudinally from side 14 to side 15 (FIGS. 2A and 3B), and are generally as spaced apart as the strings proximate the bridge of the stringed instrument. Damping block 1 may be fabricated from a vibration-absorbing material that is preferably resilient, non-rigid, and spongy. At the entrance to each slit 4-7 along the lower surface of damping block 1, is groove 8-11, respectively, that extends along the length of the slit forming an enlarged entrance into the slit along the lower surface of damping block 1. As illustrated in FIG. 3A, groove 8 is at the entrance to slit 4; groove 9 is at the entrance to slit 5; groove 10 is at the entrance to slit 6; and groove 11 is at the entrance to slit 7. Each groove 8-11 has a generally V-shaped cross section, and all slits 4-7 have generally the same height. As illustrated in FIG. 3B, each slit 4-7 has generally constant height along the length of the slit and forms a rectangular plane in damping block 1. Note that FIG. 3B illustrates only slit 4, however slits 5-7 are similar, varying only in their respective lengths, as can be seen in FIG. 2A.

As illustrated in FIGS. 1B and 5, string damper 100 may be engaged transversely across a plurality of bass guitar strings 16-19. The diameter of strings 16-19 decreases from string 16 to string 19. The distance that slits 4-7 extend upwardly into damping block 1 may be adapted to be the same for each slit (FIG. 3A), and is substantial enough such that strings 16-19, respectively, are fully engulfed when engaged to the upward extent of the slits when string damper 100 is engaged to the strings of the instrument (FIG. 6A). When strings 16-19 are engaged into slits 4-7, respectively, each string passes in and out of damping block 1 by way of passing through the lateral ends of its respective slit (FIG. 6B). Slits 4-7 are generally parallel to each other (FIG. 2A), but may also be adapted to conform to the direction of the strings, which, as is common in many stringed instruments, may converge slightly from the bridge to the nut of the stringed instrument. The resilient sponginess of damping block 1, however, will allow grooves 8-11 and slits 4-7 to accommodate slight variance in string spacing and direction.

As best seen in FIG. 3A, the lateral width of the entrance of grooves 8-11 is generally constant along its longitudinal length and may be adapted to be somewhat larger than the diameter of the largest string 16, so as to permit any of the strings 16-19 to easily pass through the entrance of any of the grooves 8-11 (FIG. 4A). The lateral width of the entrance of grooves 8-11 may also be adapted to vary as the diameter of its respective string; in this case, the lateral width of the entrance to grooves 8-11 would be somewhat larger than the diameter of the respective string 4-7.

Damping block 1 provides elastic and frictional resistance, which is communicated to strings 16-19 by way of slits 4-7, respectively, to dampen vibration of the strings, as well as provides a support structure to secure string damper 100 to the stringed instrument for normal use. Support plate 2 provides a rigid support structure for the non-rigid damping block 1 as well as a source of mass to prevent string damper 100 itself from being made to vibrate, thus allowing it to oppose vibration of strings 4-7. Support plate 2 also provides a convenient surface for a person to grasp when attaching or detaching string damper 100 from the stringed instrument. As illustrated in FIGS. 4A and 4B, grooves 8-11 provide an entrance for strings 16-19 into slits 4-7, respectively, whereby the grooves help guide and facilitate the entrance of the strings into the slits, when attaching string damper 100 to the stringed instrument. As string damper 100 is pushed downward so that strings 16-19 are forced up past grooves 8-11 into slits 4-7 (FIG. 4B), respectively, the resilient sponginess of damping block 1 allows the strings to wedge between the walls of the slits, separating the walls of the slits, thus allowing the strings to slidably move up into, and be engulfed by the slits to the full height of the slits (FIG. 6A).

Most stringed instruments have a fingerboard having a radius of curvature, whereby the strings of such instruments are evenly spaced above and generally parallel to the fingerboard, and therefore generally conform to the radius of curvature of the fingerboard. As such (referring to FIGS. 3A, 4A, 4B, and 6A), the lower surface of support plate 2 and the height of slits 4-7 into damping block 1 (shown by line b-b′ in FIG. 3A) are adapted to be longitudinally curved so as to generally conform to the radius of curvature of the stringed instrument. Once the non-rigid damping block 1 is affixed to support plate 2 it will take on the longitudinal curvature of the lower surface of the support plate. The radius of curvature of the fingerboard of like stringed instruments may vary slightly from manufacturer to manufacturer and even as well as from model to model. As such, the curvature of the aforementioned aspects of string damper 100 may be configured to approximate the radius of curvature of an average fingerboard for a given type of stringed instrument. Therefore, the height of slits 4-7 should be made substantial enough such that all strings 16-19 will be fully engulfed, if not to the full height of their respective slits. Even if string damper 100 is attached to a stringed instrument whose fingerboard has no radius of curvature and is therefore flat, the outer strings (strings 16 and 19) will be engulfed to the full height of their respective slits 4 and 7, while the inner strings (strings 17 and 18) will still be engulfed, but not to the full height of their respective slits 5-6. However, since all strings 16-19 are still engulfed by slits 4-7, respectively, string damper 100 will still function satisfactorily for stringed instruments with flat fingerboards.

Most multi-stringed instruments have different pitched strings that increase in diameter from high to low pitch. Since it may be desirable to achieve a consistent damping effect from string to string, a convenient way for string damper 100 to achieve this is for the length of slits 4-7 to vary as the diameter of strings 16-19, respectively. The larger the string diameter, the longer the slit is, and the larger the area that contacts the string, so that more damping is applied to the string. To this end, as illustrated in FIGS. 2A, 2B, and 5, string damper 100 may be configured with long side 12 and short side 13, such that the upper and lower shape of string damper 100 generally forms an isosceles trapezoid. An isosceles trapezoidal shape is provided by way of example. As illustrated in FIG. 5, string damper 100 may be oriented on the stringed instrument so that side 12 of string damper 100 engages the larger diameter strings and side 13 engages the smaller diameter strings, to advantage. With the isosceles trapezoidal shape of string damper 100, the length of slits 4-7 vary in a linear relationship, however, the lengths of slits 4-7 may also vary in a non-linear relationship (further described below as an alternate embodiment). The taper of the isosceles trapezoidal shape compensates the damping for different string diameter, and the angle of this taper, determined by the ratio of the length of sides 12 and 13, helps determine the balance of damping between strings. In one embodiment, the ratio of side 12 to side 13 may be about 2 to 1. Any shape that is symmetric about the transverse centerline of string damper 100 (as shown by line a-a′ in FIG. 2A) will work equally well on left-handed and right-handed stringed instruments. Therefore, due to the symmetric nature of an isosceles trapezoid, string damper 100 works equally well with, and can be interchanged among, left-handed and right-handed stringed instruments.

Damping block 1 may be fabricated from a material having a continuous structure of small open-cell voids such as, for example, open-cell polyurethane foam or open-cell sponge rubber. Open-cell polyurethane foam and open-cell sponge rubber provide good damping properties while not contributing any sound of their own. Damping block 1 may also be fabricated from other vibration-absorbing materials including, but not limited to, open-cell foam, closed-cell foam, closed-cell sponge rubber, synthetic elastomerics, rubber, and the like. Depending on the material used, damping block 1 may be formed by methods including, but not limited to, stamping or cutting from sheets or blocks, molding, extruding then cutting, and the like. Damping block 1 may also be fabricated from non-resilient vibration-absorbing materials such as, for example, felt.

Support plate 2 may be fabricated from a rigid material such as plastic or metal, but may also be fabricated from a variety of rigid materials including, but not limited to, wood, hard rubber, stone, bone, and the like. Depending on the material used, support plate 2 may be formed by methods including, but not limited to, cutting, carving, machining, molding, stamping from sheets, or extrusion followed by cutting, and the like. The lower surface of support plate 2 may be affixed to the upper surface of damping block 1 by a suitable adhesive such as, for example, glue, rubber cement, hot-melt glue, and the like. Also, a double-sided adhesive tape may be used, or damping block 1 may be made from an adhesive-backed vibration-absorbing material.

It is unexpectedly found that, to achieve a more pleasing tone, the firmer the material used to fabricate damping block 1, the heavier support plate 2 may be. As a general rule of thumb, the mass of support plate 2 may be proportional to the firmness of the material used to fabricate damping block 1. As an example, in one embodiment, damping block 1 and support plate 2 may be fabricated from open-cell polyurethane foam and molded plastic, respectively. In another embodiment, damping block 1 may be fabricated from open-cell sponge rubber (open-cell sponge rubber being a generally firmer material than open-cell polyurethane foam). In this embodiment, so as to achieve a more pleasing tone, support plate 2 may be fabricated from, for example, stamped metal, thereby making the plate heavier than the molded plastic plate of the previous embodiment.

Each slit 4-7, may be conveniently formed by, for example, slicing, cutting, or sawing into the lower surface of damping block 1, thus forming a flat plane for each slit. If slits 4-7 are cut before affixing damping block 1 to support plate 2, and damping block 1 is flat before being affixed to support plate 2, and support plate 2 is curved as in FIG. 3A, then slits 4-7 may need to be cut at a slight inward angle oblique to the lower surface of damping block 1, so that slits 4-7 will be oriented generally vertically, when damping block 1 (which, being flat, will bend to conform to the lower surface of support plate 2) is affixed to support plate 2. As illustrated in FIGS. 2A, 3A, 4A, 4B, and 6A, there is generally no space between the opposing walls of each slit 4-7, however the slits may also be constructed so that there is some space between the walls of a slit (describe as an alternate embodiment below). Each groove 8-11 may be formed by, for example, cutting, slicing, or sawing opposing incisions, each at about a 45° angle into the lower surface of damping block 1, along the entrance to the respective slit. Molding or extruding, as part of forming damping block 1, may also be used to form grooves 8-11.

In one embodiment, damping block 1 and support plate 2 may be fabricated from open-cell polyurethane foam and molded nylon, respectively; the thickness of damping block 1 may be about 16 mm; the thickness of support plate 2 may be about 3 mm; the lateral width of the string damper, sufficient to transversely span all the strings on the instrument, may be about 90 mm; side 12 of the string damper may be about 26 mm wide and side 13, being about half that, may be about 13 mm; and the upper surface of damping block 1 may be affixed to support plate 2 by rubber cement.

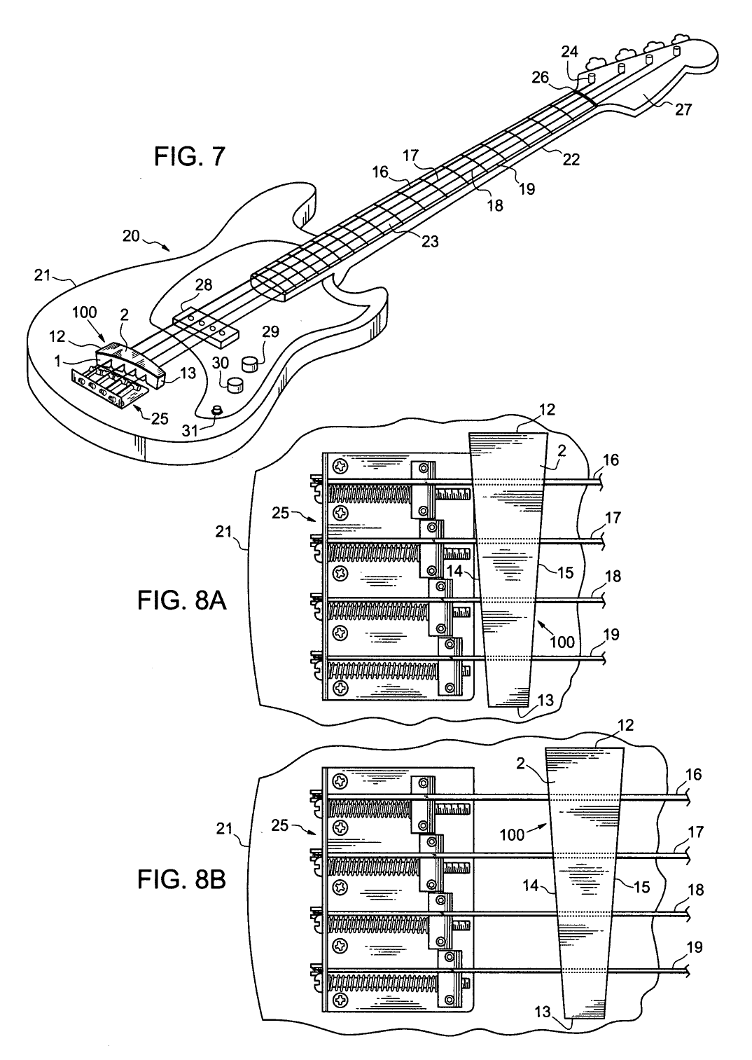

### Operation—FIGS. 7 and 8

In operation, string damper 100 provides a new string damper construction for damping the string vibrations of a stringed instrument, thereby altering the volume and tone of such stringed instrument. String damper 100 is particularly adapted to be employed in conjunction with an electric bass guitar, although it may also be employed in conjunction with any electrical or non-electrical stringed instrument such as guitar, violin, viola, cello, upright bass, banjo, mandolin, ukulele, and the like.

FIG. 7 illustrates a perspective view of string damper 100 positioned for operation on a right-handed 4-string electric bass guitar 20. Referring to FIG. 7, bass guitar 20 and the various parts thereof are shown and described for illustrative purposes to provide a better understanding of the use of the invention, and does not form part of the invention. Bass guitar 20 includes a body 21, a neck 22, a fingerboard 23, a head 27, and strings 16-19. Strings 16-19 may be spaced above and generally parallel to the fingerboard 23 and face of body 21, and conform to the radius of curvature of the fingerboard 23. Strings 16-19 may be spaced from each other, extending in a tensioned relationship from tuning screws 24 to a bridge structure 25. Strings 16-19 may extend over a nut 26 adjacent head 27, and also over a suitable pickup 28. A pickup 28 is electrically connected to controls 29 and 30 adapted to control the volume and tone of the electrical signal generated in response to vibration of one or more of strings 16-19. A jack 31 is adapted to receive a plug end of a cord that leads to a suitable amplifier and loudspeaker combination (not shown). In FIG. 7, string damper 100 is attached to bass guitar 20 transversely across strings 16-19 proximate to bridge structure 25, and oriented with side 12 engaged to the larger diameter strings, and side 13 engaged to the smaller diameter strings.

Referring to FIG. 7, string damper 100 may be operated by placing string damper 100 transversely across strings 16-19 of bass guitar 20 proximate bridge structure 25, such that strings 16-19 enter into the corresponding grooves 8-11 on the lower surface of damping block 1 (FIG. 4A). Grooves 8-11 guide and facilitate the entrance of strings 16-19, into slits 4-7, respectively. The string damper is then pushed toward body 21 to force strings 16-19 up into slits 4-7 (FIG. 4B), respectively, thus easily engaging string damper 100 to bass guitar 20. Preferably, strings 16-19 are engaged to the full height of slits 4-7 (FIG. 6A). Once strings 16-19 are engaged into slits 4-7, respectively, the strings encounter the resiliency of damping block 1, which elastically and frictionally offers resistance to the strings, thereby damping any string vibration as well as securing string damper 100 to the strings, and hence to the bass guitar 20 for normal use. The resulting dampened sound is lowered in volume and more staccato and muted in tone. It is unexpectedly found that the muted staccato tone is similar to that of an acoustic upright bass. As illustrated in FIGS. 7, 8A, and 8B, string damper 100 may be oriented with the thicker strings engaged in side 12 and the thinner strings engaged in side 13, thereby providing an even balance of damping from string to string. String damper 100 may be easily disengaged from bass guitar 20 by grasping string damper 100 and simply pulling such string damper 100 off strings 16-19 of bass guitar 20. With the symmetric nature of its isosceles trapezoidal shape, string damper 100 may be used equally well on left-handed and right-handed electric bass guitars.

FIGS. 8A and 8B illustrate an enlarged top plan view of string damper 100 positioned for operation at alternate positions on bass guitar 20. The position of string damper 100 in FIG. 8A is closer to the bridge structure 25 than the position of string damper 100 in FIG. 8B. String damper 100 is not limited to these two positions but may be attached to bass guitar 20 along any portion of strings 16-19 that slits 4-7 can accommodate. It has been observed that variations in damping may be achieved by attaching string damper 100 at different distances from bridge structure 25, whereby increasing the distance generally increases the damping effect. Depending on the position of string damper 100 along the strings of bass 20, the tone may be made similar to an acoustic upright bass.

In operation, the material, shape, and size of damping block 1 and support plate 2 each have an effect on the damping action of string damper 100, and hence the volume and tone of the stringed instrument to which string damper 100 is attached. The quality of the tone of the stringed instrument is a subjective matter subject to personal taste, and as such, damping block 1 and support plate 2 may be constructed from a variety of materials and may assume a variety of shapes and sizes so as to achieve a satisfactory volume and tone.

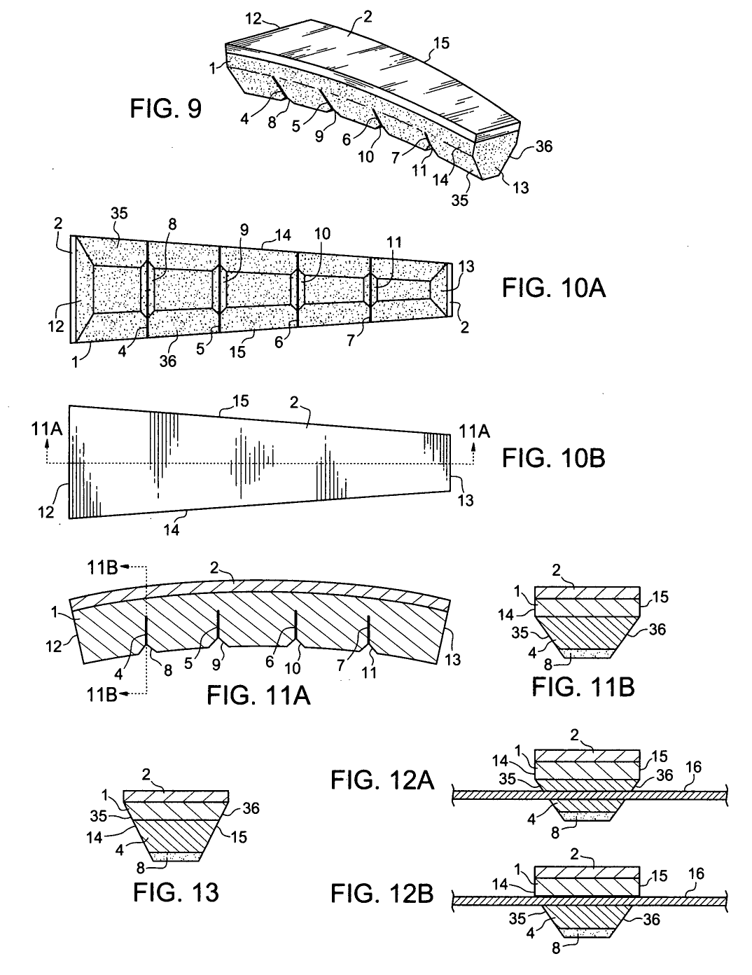

### Description—FIGS 9 to 27—Alternate Embodiments

FIG. 9 illustrates a front perspective view of a string damper having damping block 1 with side 14 having a beveled lower edge 35 and side 15 having a beveled lower edge 36. The angle of bevels 35 and 36, to the lower surface of damping block 1 may, for example, be each about 60 degree. As illustrated in FIGS. 10A and 10B, the string damper has long parallel side 12 and short parallel side 13 and has an isosceles trapezoidal shape, similar to string damper 100. As illustrated in FIG. 11A, the front cross section of the string damper is longitudinally curved to conform to the radius of curvature of the stringed instrument, also similar to string damper 100. As illustrated in FIG. 11B, due to beveled sides 35 and 36, the length of slit 4 increases with the height of the slit. In FIGS. 12A and 12B, string 16 can be seen engaged into slit 4 at a lower height and a higher height, respectively. As the length of slit 4 increases with height, the area in contact with string 16 increases, and hence the damping increases. As such, the damping for string 16 in FIG. 12B is greater than the damping for string 16 in FIG. 12A. As therefore can be seen, the string damper of FIG. 9 provides the capability to control the damping amount by the height that a string is pushed up into the slits. Bevels 35 and 36 also may allow the string damper to be attached to the instrument at a position closer to the bridge structure. In FIG. 11B, the face of bevels 35 and 36 are shown as flat, but may also be curved convexly or concavely, or stepped.

FIG. 13 illustrates a side cross-sectional view of a string damper similar to the string damper of FIG. 9, but with bevels 35 and 36 extending the full height of side 14 and side 15, respectively.

FIG. 14 illustrates a cross-sectional view of a string damper having only damping block 1 with slits 4-7. The string damper in FIG. 13 has no support plate affixed to the upper surface of damping block 1 and no grooves at the entrance of slits 4-7. This string damper is still able to be attached to the stringed instrument and damp the strings in a similar manner to string damper 100.

FIG. 15 illustrates a cross-sectional view of a string damper with damping block 1 affixed to a support plate 2, and with damping block 1 having slits 4-7, but with no grooves at the entrance of slits 4-7. This string damper is still able to be attached to the stringed instrument and damp the strings in a similar manner to string damper 100.

FIG. 16 illustrates a cross-sectional view of a string damper having a flat support plate 2 and a flat damping block 1. Slits 4-7 may all extend upwardly into damping block 1 to a constant height.

FIG. 17 illustrates a cross-sectional view of a string damper with damping block 1 having a flat lower surface.

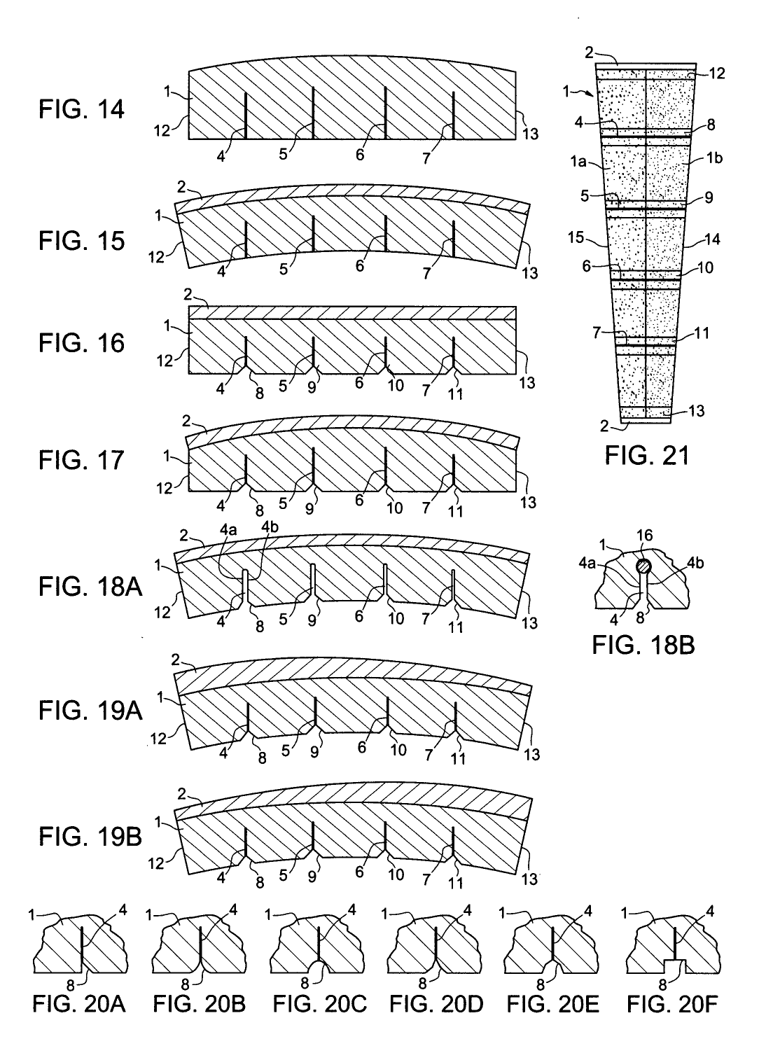

FIG. 18A illustrates a cross-sectional view of a string damper with slits 4-7 having space between the opposing walls of each slit. The distance between the opposing walls of slits 4-7 may be made somewhat smaller than the diameter of the string it is intended to accept, so that the distance between opposing walls increases with string diameter. Referring to FIG. 18B, slit 4 is shown with opposing walls 4a and 4b engaging string 16; slits 5-7, though not shown, have similar opposing walls. As can be seen, opposing walls 4a and 4b are still close enough together so that they are able to contact string 16 and provide frictional and elastic resistance to the string, so as to grip the string and damp vibration of the string. Distance between the opposing walls of a slit may be needed if the material of damping block 1 is substantially firm, and/or the strings of the stringed instrument are quite thick, and/or the strings are in pairs (such as mandolin or 12-string guitar).

FIGS. 19A and 19B show front cross-sectional views of a string damper with support plate 2 having a thickness that tapers laterally from side 12 to side 13. In FIG. 19A, support plate 2 is thicker towards side 12 and decrease gradually in thickness towards side 13. In FIG. 19B, support plate 2 is thinner towards side 12 and gradually increases in thickness towards side 13. The tapering thickness of the support plate may be used to alter the balance of damping between strings.

FIGS. 20A to 20F illustrate cross-sectional views of various embodiments of grooves. FIG. 20A illustrates groove 8 with a V-shape on only one wall, and with the opposite wall being vertical with respect to the lower surface of damping block 1. FIGS. 20B and 20C illustrate groove 8 with curved convex and curved concave walls, respectively. FIGS. 20D and 20E illustrate groove 8 with faceted convex and faceted concave walls, respectively. FIG. 20F illustrates groove 8 with vertical walls, thus having a rectangular cross section. Note that FIGS. 20A-20F illustrate only groove 8, however, the embodiments shown also apply to grooves 9-11, as well as any grooves.

FIG. 21 illustrates a bottom plan view of a string damper having a damping block 1 made up of a plurality of sections 1a and 1b adjacent each other along a transverse border. Sections 1a and 1b may be fabricated from different materials to achieve a better damping effect. For example, in one embodiment, section 1a may be fabricated from open-cell polyurethane foam and section 1b from a firmer material such as open-cell sponge rubber. Sections 1a and 1b extend transversely from side 12 to side 13. The number of sections may be more than the two shown to provide finer control of the damping effect. Also, the sections may be joined along a longitudinal border so that they extend longitudinally from side 14 to side 15, forming a damping block with different sections for different slits.

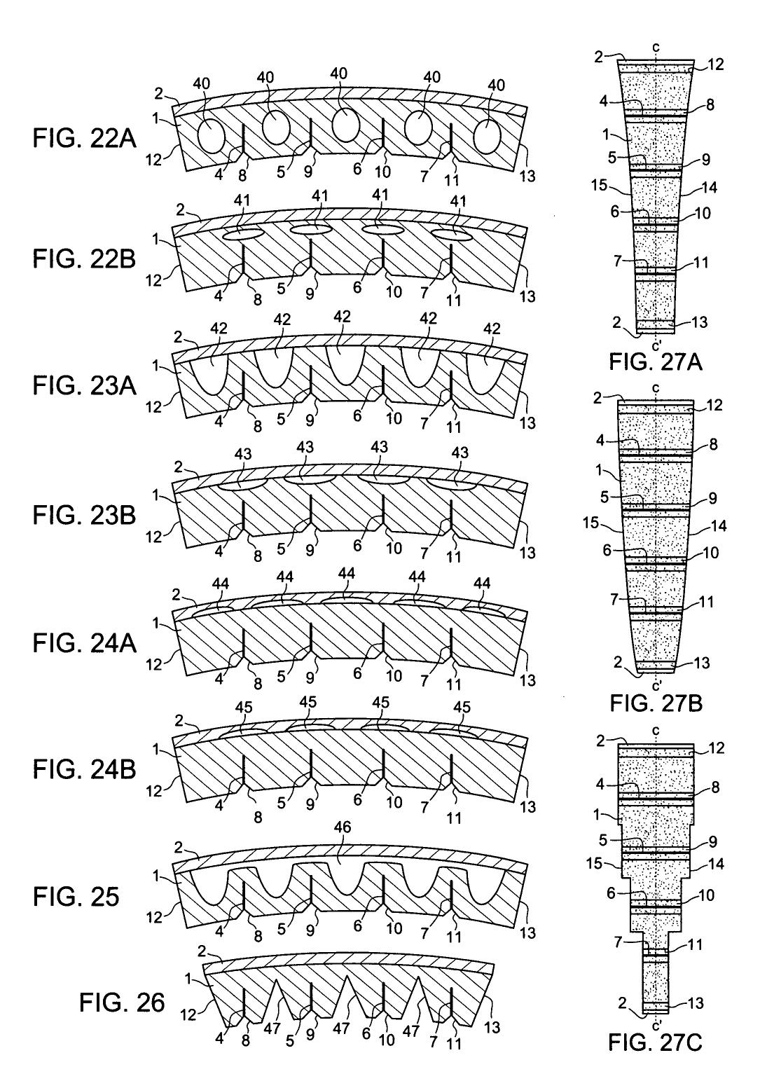

FIGS. 22A and 22B illustrate front cross-sectional views of a string damper having longitudinal voids 40 and 41, respectively, in the interior of damping block 1. In FIG. 22A, voids 40 are disposed adjacent slits 4-7; in FIG. 22B, voids 41 are disposed above slits 4-7.

FIGS. 23A and 23B illustrate front cross-sectional views of a string damper having longitudinal channels 42 and 43, respectively, along the upper surface of damping block 1. In FIG. 23A, channels 42 are disposed adjacent slits 4-7; in FIG. 23B, channels 43 are disposed above slits 4-7.

FIGS. 24A and 24B illustrate front cross-sectional views of a string damper having longitudinal channels 44 and 45, respectively, along the lower surface of support plate 2. In FIG. 24A, channels 44 are disposed above and adjacent slits 4-7; in FIG. 24B, channels 45 are disposed above slits 4-7.

FIG. 25 illustrates a front cross-sectional view of a string damper having a longitudinal channel 46 along the upper surface of damping block 1. Channel 46 spans over slits 4-7, scooping down between and adjacent the slits. The upper surface of damping block 1 is affixed to support plate 2 only at sides 12 and 13. Channel 46 may be formed, for example, by the extrusion and cutting of damping block 1.

FIG. 26 illustrates a front cross-sectional view of a string damper having longitudinal channels 47 along the lower surface of damping block 1. Channels 47 are disposed between slits 4-7 and extend upwardly into damping block 1. The height of channels 47 may also be made to extend to the upper surface of block 1, thereby further decoupling the vibration of one string from another string.

In FIGS. 22 to 26, voids 40-41 and channels 42-47 provide convenient ways to decouple the vibration of one string from another string. Voids 40-41 and channels 42-47 may extend throughout the string damper from side 14 to side 15 and have a variety of cross-sectional shape variations.

FIGS. 27A to 27C illustrate bottom plan views of a string damper showing some examples of configurations of side 14 and side 15 that provide for a non-linear relationship in slit length. In FIG. 27A, sides 14 and 15 are curved concavely; in FIG. 27B, sides 14 and 15 are curved convexly; and in FIG. 27C, sides 14 and 15 are stepped. The configurations in FIGS. 27A to 27C are symmetrical about line c-c′ and work equally well on left-handed and right-handed stringed instruments.

The alternate embodiments of FIGS. 9-27 operate in a similar manner to string damper 100, and may, for some of these embodiments, be combined with one another to form other embodiments. For example, attributes of the string dampers of FIGS. 9, 18, and 21, may be combined to form an embodiment of a string damper having beveled front and rear lower edges 35 and 36, respectively, space between opposing walls of slits 4-7, and damping block 1 having two-sections 1a and 1b.

### Conclusion, Ramifications, and Scope

Accordingly, the reader can see that the string damper of this invention provides a string damper that is portable and not fixedly attached to the stringed instrument so that it can be detached from the stringed instrument and be shared between other like instruments, and that is easily and quickly attached and detached from the stringed instrument and without having to operate a mechanism or the need for tools, and that does not require or produce any permanent changes or scars (such as screw holes) to the stringed instrument when attached to the instrument, and in which the damping mechanism also provides the mechanism by which the damper is secured to the stringed instrument for normal use, thereby eliminating extra securing apparatus, and that can contact the strings along a range of positions, thereby affording a range of damping effects, and that provides an even balance of damping from the thicker low-pitched strings to the thinner high-pitched strings, and that is adaptable to work on a variety of types of stringed instruments, and that works equally well on, and can be interchanged among, left-handed and right-handed stringed instruments, and that when employed in conjunction with an electric bass guitar, enhances the tone so as to simulate the tone of an acoustic upright bass, and that has a simple and novel construction that is inexpensively and easily manufactured.

While the above description contains many specificities, these should not be construed as limitations on the scope, but as exemplifications of the presently preferred embodiments thereof. Many other ramifications and variations are possible within the teachings. For example:

The string damper may be adapted to have a second damping block, perhaps of a different material or size, affixed to the upper surface of the plate, thereby providing two string dampers in one apparatus. Also, the plate could be adapted to have three or more longitudinal sides to which could each be affixed a separate damping block, thereby providing three or more string dampers in one apparatus

The string damper may be adapted so that the number of grooves and slits, and hence the width of the string damper, may be constructed to accommodate less than the total number of strings on the instrument. In this case, for example, string damper 100 could be constructed with only three slits and grooves and made less wide, so that when engaged to the 4-string instrument, three adjacent strings would be damped while the remaining string would be undamped.

The string damper may be adapted for electrical and non-electrical stringed instruments with any number of strings by adjusting the number and spacing of slits and grooves, and correspondingly the width of the string damper so as to conform to the number and spacing of strings on the instrument.

The damping block may be fabricated from laminations of different types of vibration-absorbing materials that are affixed together so as to achieve a better balanced or improved damping effect.

The slits may extend upwardly into the block to the full height of the block.

The string damper, besides the isosceles trapezoidal shape, may have some other symmetrical shapes such as, for example, rectangular, rhomboid, or oval. The string damper could also have a non-symmetrical shape such as, for example, parallelogram or right trapezoid. However, symmetrical shapes allow the string damper to work equally well on left-handed and right-handed instruments.

The support plate may also be detachably affixed to the damping block by, for example, VELCRO®, whereby, for example, the hook half of the VELCRO® tape is adhered to the upper surface of the damping block and the loop half of the VELCRO® tape is adhered to the lower surface of the plate. This would allow the interchange of support plates with damping blocks.

A fabric-backed sheet or strip of resilient non-rigid spongy material may be used for the damping block material. In this case, the fabric-backed side forms the upper surface of the damping block, and the support plate could be eliminated, whereby the fabric backing would provide a non-rigid support for the damping block.

The edge of the support plate may extend slightly over the edge of the upper surface of the damping block thereby providing a more prominent edge for grasping. The support plate may also have a shape other than the shape of the upper surface of the damping block.

Multiple string dampers may be placed on the stringed instrument side by side to further increase and vary the damping effect.

The upper surface of the support plate may have a knob-like or handle-like extension extending upwardly out from it. This extension may help a person to better grasp the string damper when engaging or disengaging it from the stringed instrument.

The upper surface of the support plate may have a strip of VELCRO® hook or loop affixed to it by some suitable adhesive, so that the invention, when not in use, may be conveniently attached to the opposite strip of VELCRO® loop or hook that is affixed to the stringed instrument.

Accordingly, the scope of this invention should be determined by the appended claims and their legal equivalents, rather than by the examples given in the descriptions above.

I claim:

1. A string damper for a stringed instrument comprising
an elongated block of vibration-absorbing material sufficiently wide enough to transversely span a plurality of adjacent strings of said stringed instrument,
a plurality of slits disposed along the lower surface of said block where said slits extend upwardly into said block and longitudinally span the front and rear surfaces of said block and are generally parallel and generally spaced apart as said strings on said stringed instrument proximate the bridge of said stringed instrument
a groove that extends along the length of the entrance to each said slit along the lower surface of said block forming an enlarged entrance into said slit so as to facilitate entrance of said strings into said slits,
a rigid support surface secured to the upper surface of said block so as to provide support to said block and provide mass to said string damper so as to oppose vibration of said strings and provide a convenient grasping surface,
whereby one or more of said strings of said stringed instrument may be urged into and engaged by said slits so as to damp vibration of said strings and detachably attach said string damper to said stringed instrument.

2. The string damper of claim 1 wherein said string damper has a long lateral side and a short lateral side such that the length of said slits varies proportionally with the diameter of said strings.

3. The string damper of claim 1 wherein the upper shape and lower shape of said string damper is symmetric about the transverse centerline of said string damper.

4. The string damper of claim 1 wherein the upper shape and lower shape of said string damper generally forms an isosceles trapezoid where the lateral sides of said string damper form the parallel sides of the trapezoid.

5. The string damper of claim 1 wherein said string damper is longitudinally curved to conforms to radius of curvature of the fingerboard of said stringed instrument.

6. The string damper of claim 1 wherein said grooves have a generally V-shaped cross section.

7. The string damper of claim 1 wherein said block is composed of a resilient spongy material having a continuous structure of small open-cell voids.

8. The string damper of claim 1 wherein said block is composed of open-cell polyurethane foam and said plate is composed of plastic.

9. The string damper of claim 1 wherein said block is composed of open-cell sponge rubber and said plate is composed of metal.

10. The string damper of claim 1 wherein said block has a beveled lower front edge and a beveled lower rear edge.

11. The string damper of claim 1 wherein each said slit has some distance between the opposing walls of said slit.

12. The string damper of claim 1 wherein said block has longitudinal voids that pass through said block.

13. The string damper of claim 1 wherein said plate has longitudinal channels disposed along the lower surface of said plate.

14. The string damper of claim 1 wherein said block is composed of a plurality of sections.

15. A string damper for a stringed instrument comprising
an elongated block of vibration-absorbing material sufficiently wide enough to transversely span a plurality of adjacent strings of said stringed instrument,
a plurality of slits disposed along the lower surface of said block where said slits extend upwardly into said block and longitudinally span the front and rear surfaces of said block and are generally parallel and generally spaced apart as said strings on said stringed instrument proximate the bridge of said stringed instrument,
whereby one or more of said strings of said stringed instrument may be urged into and engaged by said slits so as to damp vibration of said strings and detachably attach said string damper to said stringed instrument.

16. The string damper of claim 15, further including a rigid support surface secured to the upper surface of said block so as to provide support to said block and provide mass to said string damper so as to oppose vibration of said strings and provide a convenient grasping surface for said string damper.

17. The string damper of claim 15, further including a groove that extends along the length of the entrance to each said slit along the lower surface of said block forming an enlarged entrance into said slit so as to facilitate entrance of said strings into said slits.

18. A string damper for a stringed instrument comprising
an elongated block of vibration-absorbing material sufficiently wide enough to transversely span a plurality of adjacent strings of said stringed instrument,
a coupling means for coupling said block to said strings of said stringed instrument,
whereby one or more of said strings of said stringed instrument may be engaged by said block by way of said coupling means so as to damp vibration of said strings and detachably attach said string damper to said stringed instrument.

19. The string damper of claim 18, further including a rigid support surface secured to the upper surface of said block so as to provide support to said block and add mass to said string damper so as to oppose vibration of said strings and provide a convenient grasping surface for said string damper.

20. The string damper of claim 18, wherein said coupling means includes a plurality of slits disposed along the lower surface of said block where said slits extend upwardly into said block and longitudinally span the front and rear surfaces of said block and are generally parallel and generally spaced apart as said strings on said stringed instrument proximate the bridge of said stringed instrument.
